(19) United States
(12) Patent Application Publication
(10) Pub. No.: US 2023/0415242 A1
(43) Pub. Date: Dec. 28, 2023

(54) WORKPIECE CLAMPING DEVICE AND MACHINE TOOL

(71) Applicant: FUJI CORPORATION, Chiryu (JP)

(72) Inventor: Hideo GOTSU, Okazaki-shi (JP)

(73) Assignee: FUJI CORPORATION, Chiryu (JP)

(21) Appl. No.: 18/308,861

(22) Filed: Apr. 28, 2023

(30) Foreign Application Priority Data
Jun. 23, 2022 (JP) 2022-101123

(51) Int. Cl. B23B 31/16; B23B 25/04

(52) U.S. Cl. CPC B23B 31/16287; B23B 31/16275; B23B 25/04

(57) ABSTRACT

A workpiece clamping device includes a chuck main body, multiple first chuck claws attached to the chuck main body, a second chuck claw attached to the chuck main body, and a driving source configured to move the first chuck claws and the second chuck claw to clamp a workpiece having a rectangular shape, in which the multiple first chuck claws each have a pair of first contact portions, are disposed at positions of different corners, respectively, on a rectangular workpiece, and bring each of the pair of first contact portions into contact with two sides forming the corner to hold the corner, and the second chuck claw has a second contact portion, and is configured to bring the second contact portion into contact with one side of the workpiece to hold the one side of the workpiece.

### TECHNICAL FIELD

The present disclosure relates to a workpiece clamping device and a machine tool that clamp a workpiece having a rectangular shape by chuck claws.

### BACKGROUND ART

In the conventional art, various workpiece clamping devices that clamp a workpiece by multiple chuck claws have been proposed. Patent Literature 1 discloses a workpiece clamping device that clamps a workpiece having a quadrangular shape by three chuck claws. Among the three chuck claws of Patent Literature 1, distal ends of the two chuck claws are formed into a straight line that comes into contact with one side of the workpiece. In addition, a distal end of the remaining one chuck claw has a square shape that comes into contact with two sides of the workpiece.

### PATENT LITERATURE

Patent Literature 1: JP-A-H05-63708 (paragraphs 0005 and 0016)

### SUMMARY OF THE INVENTION

### Technical Problem

In the workpiece clamping device described above, only one corner of multiple corners is held by the chuck claw with respect to the workpiece having the rectangular shape, and there is a concern that a positional deviation occurs when the workpiece is clamped. Therefore, there is room for improvement as the workpiece clamping device that clamps the workpiece having the rectangular shape.

The present disclosure has been made in view of the above-described problems, and an object is to provide a workpiece clamping device and a machine tool capable of accurately clamping a workpiece having the rectangular shape.

### Solution to Problem

In order to solve the above-described problems, the present description discloses a workpiece clamping device including a chuck main body, multiple first chuck claws attached to the chuck main body, a second chuck claw attached to the chuck main body, and a driving source configured to move the first chuck claws and the second chuck claw to clamp a workpiece having a rectangular shape, in which the multiple first chuck claws each have a pair of first contact portions, are disposed at positions of different corners, respectively, on the workpiece having the rectangular shape, and are each configured to bring each of the pair of first contact portions into contact with two sides forming the corner to hold the corner, and the second chuck claw has a second contact portion, and is configured to bring the second contact portion into contact with one side of the workpiece having the rectangular shape to hold the one side of the workpiece.

The content of the present disclosure is not limited to implementation as the workpiece clamping device, but is also extremely effective to implementation as a machine tool including the workpiece clamping device.

### Advantageous Effect of the Invention

With the workpiece clamping device and the machine tool of the present disclosure, multiple corners of the workpiece having the rectangular shape are held by the multiple first chuck claws, respectively, while one side is held by the second chuck claw. The first chuck claw brings each of the pair of first contact portions into contact with two sides of the corner to hold the corner. As a result, by holding the multiple corners by the multiple first chuck claws, respectively, it is possible to suppress a positional deviation that occurs when the workpiece having the rectangular shape is clamped, and the workpiece having the rectangular shape can be clamped accurately.

### BRIEF DESCRIPTION OF DRAWINGS

FIG. 1 is a front view of a machine tool according to the present embodiment.

FIG. 2 is a block diagram of the machine tool.

FIG. 3 is a perspective view showing a main body part of the machine tool from which a device cover is detached.

FIG. 4 is a plan view and a partially enlarged view of a chuck main body, and first and second chuck claws.

FIG. 5 is a perspective view of the chuck main body, and the first and second chuck claws.

FIG. 6 is a perspective view of an attachment part of an attachment portion.

FIG. 7 is a perspective view of the second chuck claw.

FIG. 8 is a cross-sectional view taken along a line I-I shown in FIG. 7 and viewed from an arrow direction.

FIG. 9 is a plan view showing a state in which a workpiece is clamped by the first and second chuck claws.

FIG. 10 is a perspective view of first chuck claw 32.

FIG. 11 is a perspective view of a cover member.

FIG. 12 is a perspective view of the cover member.

FIG. 13 is a plan view of the chuck main body and the first and second chuck claws in a state in which the cover member is detached.

FIG. 14 is a perspective view showing a state in which an adjustment ring is clamped.

### DESCRIPTION OF EMBODIMENTS

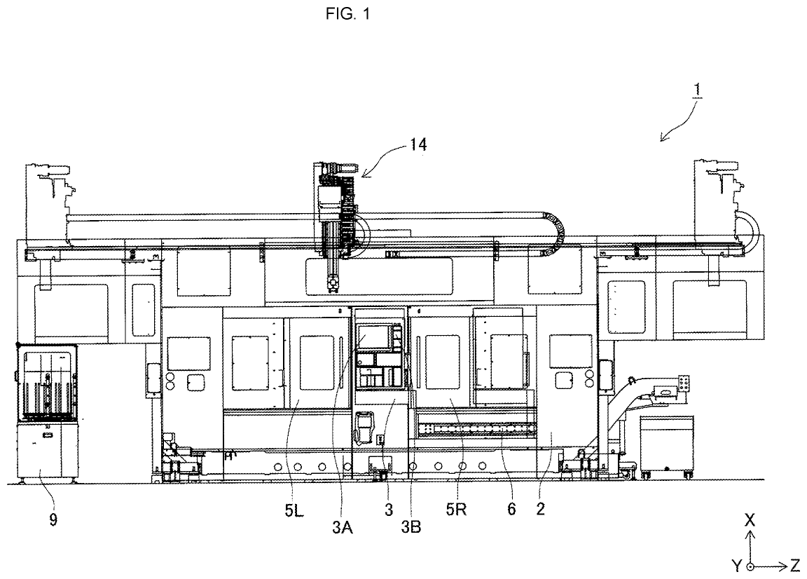

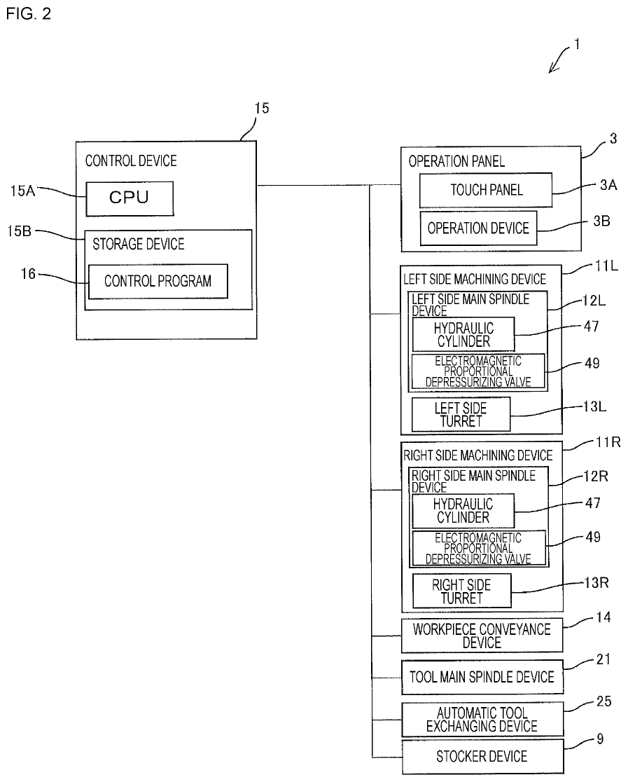

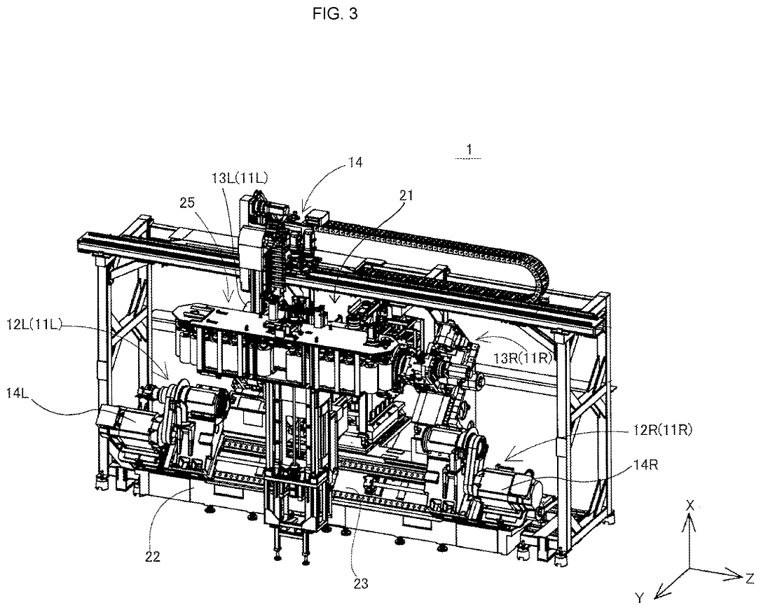

Hereinafter, an embodiment of a machine tool of the present disclosure will be described in detail with reference to the accompanying drawings. FIG. 1 shows a front view of machine tool 1 of the present embodiment. FIG. 2 shows a block diagram of machine tool 1. FIG. 3 shows a perspective view of a main body part of machine tool 1 from which device cover 2 (see FIG. 1) is detached. In the following description, as shown in FIG. 1, the description will be made by referring, with a direction when machine tool 1 is viewed from the front surface as a reference, a right direction, which is a tool width direction and is a direction horizontal to an installation surface of the device, to as a Z direction, a front direction, which is parallel to the installation surface of the device and perpendicular to the Z direction, to as a Y direction, and an upper direction, which is perpendicular to the Z direction and the Y direction, to as an X direction. In the following description, a character [L] is generally added to a sign related to the device disposed on a left side of machine tool 1, and a character [R] is added to a sign related to the device disposed on a right side of machine tool 1.

### Configuration of Machine Tool 1

As shown in FIGS. 1 and 2, a front face of machine tool 1 is covered with device cover 2, and movable operation panel 3 is provided on a front surface of the tool. Operation panel 3 is movable in the Z direction from the center to a right end of a front face of the device along rail 6 provided on a lower right side of the front face of device cover 2. Device cover 2 is provided with left side front door 5L on the left side and is provided with right side front door 5R on the right side of machine tool 1. Left side and right side front doors 5L and 5R are, for example, slide doors, and can access a machining space behind the doors by opening the doors.

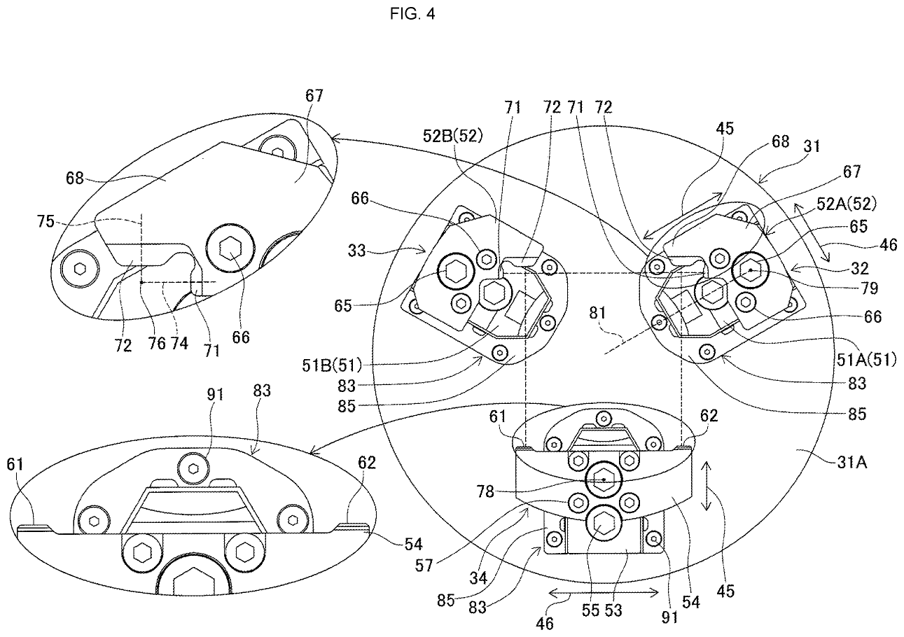

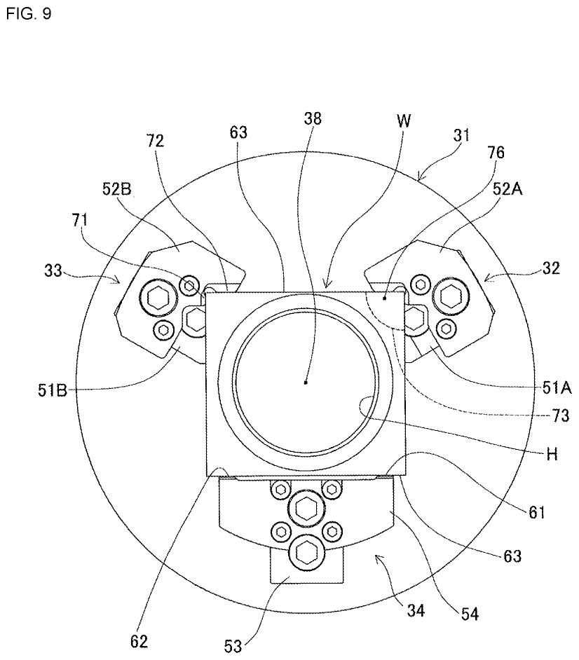

As shown in FIGS. 1 to 3, machine tool 1 includes left side machining device 11L, right side machining device 11R, stocker device 9, workpiece conveyance device 14, control device 15, tool main spindle device 21, and automatic tool exchanging device 25, in addition to operation panel 3. The machining space of left side machining device 11L is provided behind left side front door 5L. Left side machining device 11L is, for example, a turret-type lathe, and includes left side main spindle device 12L and left side turret 13L. Chuck main body 31 (see FIG. 4) described later is attachable to left side main spindle device 12L. Multiple chuck claws that clamp (chuck) a workpiece are attachable to chuck main body 31. Left side main spindle device 12L clamps the workpiece by the multiple chuck claws, and rotates workpiece W (see FIG. 9) about a main spindle parallel to the Z direction. Left side turret 13L has a tool rest to which multiple tools (rotating tool or cutting tool) are attachable, and executes tool indexing. Left side turret 13L executes machining (cutting, drilling, or the like) on workpiece W (see FIG. 9) clamped by left side main spindle device 12L by the indexed tool. Right side machining device 11R has the same configuration as left side machining device 11L except for the direction of the main spindle (device), and includes right side main spindle device 12R and right side turret 13R. FIG. 3 shows a state in which chuck main body 31 is detached.

The main spindle of right side main spindle device 12R is parallel to the Z direction and faces the main spindle of left side main spindle device 12L in the left-right direction. Therefore, left side and right side machining devices 11L and 11R are so-called facing biaxial-type lathes disposed symmetrically in the left-right direction. Left side and right side machining devices 11L and 11R need not have configurations symmetrical in the left-right direction. In addition, right side machining device 11R need not have the same configuration as left side machining device 11L. For example, at least one of left side machining device 11L and right side machining device 11R may be another type of machining device, such as a machining center.

Machine tool 1 is a multifunctional machining machine having both functions of an NC lathe and a machining center. Machine tool 1 includes a multifunctional machining machine including left side and right side machining devices 11L and 11R, and tool main spindle device 21 on one bed 22. Tool main spindle device 21 is provided substantially at the center of machine tool 1 in the left-right direction. Tool main spindle device 21 executes machining that is difficult by left side and right side machining devices 11L and 11R that are lathes. Tool main spindle device 21 can execute, for example, drilling or the like on the workpieces gripped, respectively, by left side and right side main spindle devices 12L and 12R, in addition to lathing, and can execute workpiece machining at a depth or an angle that is difficult by left side and right side turrets 13L and 13R.

Each of left side and right side main spindle devices 12L and 12R rotates workpiece W (see FIG. 9) based on the driving of spindle motors 14L and 14R provided outside the device. In addition, left side and right side main spindle devices 12L and 12R including spindle motors 14L and 14R are movable by sliding in a direction parallel to the Z direction along inclined surface 23 on bed 22 having a slant bed structure. Left side and right side main spindle devices 12L and 12R, for example, drive a ball screw mechanism (not shown) by a Z-axis servo motor (not shown) provided at a lower portion, and move in the direction parallel to the Z direction. Both left side and right side turrets 13L and 13R and tool main spindle device 21 are movable in a front-rear direction of a tool body and an up-down direction of the tool body orthogonal to the main spindle. For example, the movement direction of tool main spindle device 21 is in the X direction vertical to the horizontal Y direction, whereas the movement directions of left side and right side turrets 13L and 13R are in the YL direction and the XL direction inclined by 45 degrees in the Y direction and the X direction.

In addition, automatic tool exchanging device 25 is provided on a front side of tool main spindle device 21. Tool main spindle device 21 can replace the tool (main spindle head tool) with automatic tool exchanging device 25. Automatic tool exchanging device 25 includes a tool magazine in which the multiple tools are accommodated in an upper part of the device, and conveys a tool for exchanging from the tool magazine to a tool exchanging position of tool main spindle device 21 by a tool changer provided at a position facing tool main spindle device 21.

Machine tool 1 can also execute tool exchanging of tool main spindle device 21 while the machining of workpiece W is executed by each of left side and right side machining devices 11L and 11R. Machine tool 1 includes, for example, separation shutters (not shown) disposed on both left and right sides of tool main spindle device 21 in the Z direction, respectively. Machine tool 1 can individually move two separation shutters in the Y direction by a driving mechanism (not shown). FIG. 3 shows a state in which the separation shutter is accommodated. Machine tool 1 separates the machining space of each of left side machining device 11L and right side machining device 11R and a tool exchanging space of tool main spindle device 21 by the two separation shutters. As a result, it is possible to prevent each device from being affected by a coolant or a chip. In addition, by closing only one separation shutter, the space including the tool exchanging space can be extended to the machining space of one turret or tool main spindle device 21.

In addition, workpiece conveyance device 14 is, for example, a gantry-type autoloader, and executes delivery of workpiece W with each device, such as left side and right side machining devices 11L and 11R, and stocker device 9 that conveys in and discharges workpiece W. Operation panel 3 is provided on the front face of device cover 2, and includes touch panel 3A or operation device (push button, switch, or the like) 3B.

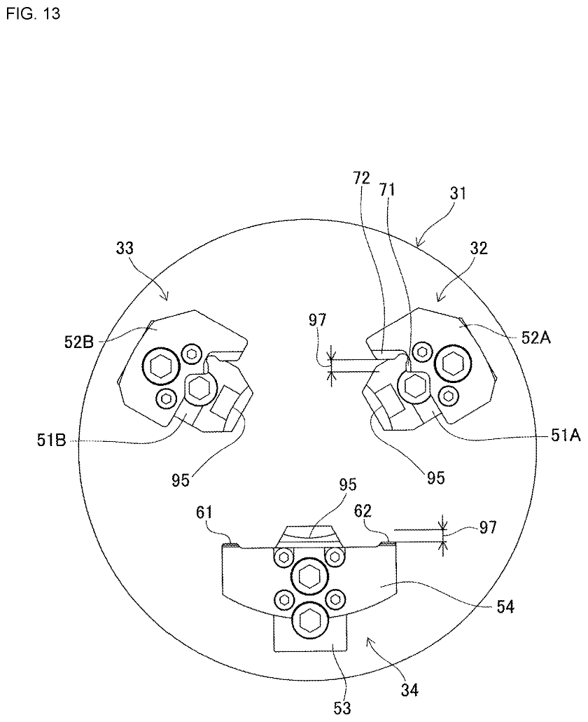

As shown in FIG. 2, control device 15 of machine tool 1 includes CPU 15A and storage device 15B, and is a processing device mainly including a computer. Storage device 15B includes, for example, RAM, ROM, a flash memory, and the like. Control device 15 is electrically connected to each device (left side machining device 11L, workpiece conveyance device 14, or the like) to be able to control each device. Various control programs 16 are stored in storage device 15B. Control program 16 includes, for example, an NC program for controlling the operation of each of left side and right side machining devices 11L and 11R in the machining of workpiece W, a program for controlling the operation of workpiece conveyance device 14, a program for a ladder circuit for processing various signals, and the like. In addition, control program 16 includes a program for setting the machining position in the machining of clearance 97 (see FIG. 13) for the chuck claw (sub claw) described later.

### Chuck Main Body 31, First Chuck Claws 32 and 33, and Second Chuck Claw 34

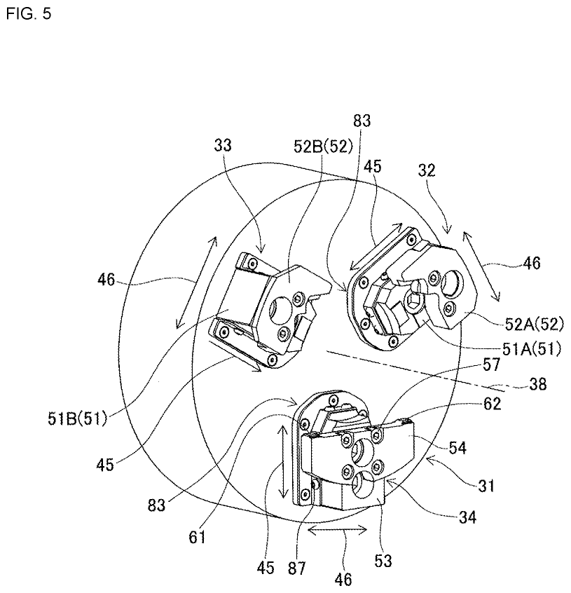

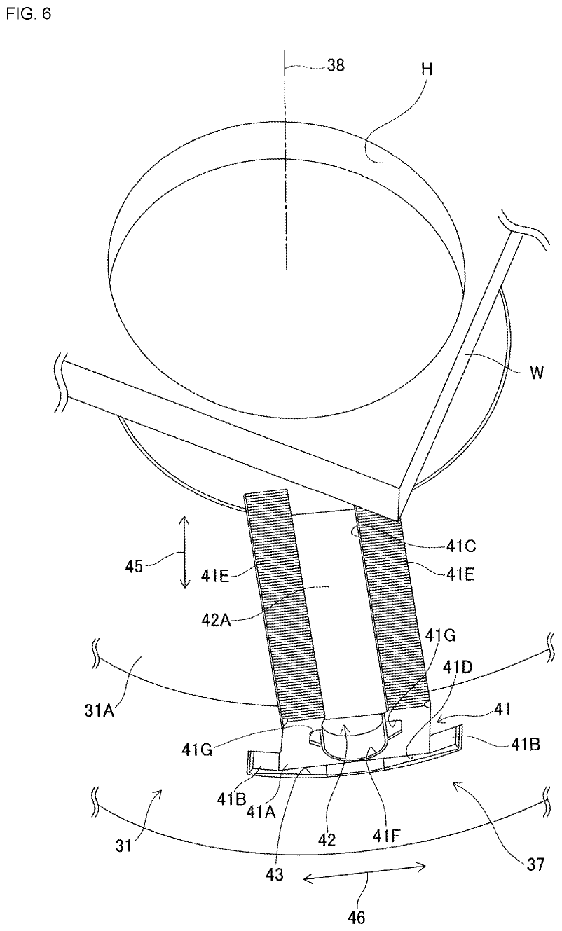

Next, chuck main body 31 attached to left side and right side main spindle devices 12L and 12R will be described. FIG. 4 shows a plan view in which first chuck claws 32 and 33 and second chuck claw 34 are attached to chuck main body 31, and FIG. 5 shows a perspective view. FIG. 6 shows a perspective view of attachment portion 37 of chuck main body 31. FIGS. 4 and 5 show chuck main body 31 in a simplified manner, but do not show attachment portion 37, insertion groove 43, or the like shown in FIG. 6.

As shown in FIGS. 4 to 6, chuck main body 31 has a substantially cylindrical shape having a predetermined thickness in a direction along main spindle 38 (hereinafter, may be referred to as a main spindle direction). Three attachment portions 37 (see FIG. 6) are attached to chuck main body 31. Three attachment portions 37 are disposed at equal intervals (at intervals of 120 degrees) in a circumferential direction of chuck main body 31, for example. First chuck claws 32 and 33 and second chuck claw 34 are attachable to three attachment portions 37, respectively.

As shown in FIG. 6, attachment portion 37 includes slide portion 41 and reception portion 42. Chuck main body 31 is provided with insertion groove 43 at a position at which attachment portion 37 is attached (position for each 120 degrees). Insertion groove 43 is a groove formed along a radial direction of chuck main body 31 having the cylindrical shape and being open to a side of workpiece W (side of upper surface 31A in FIG. 6). Insertion groove 43 is formed to correspond to an outer shape of slide portion 41. Slide portion 41 is movable by sliding in the radial direction in a state in which slide portion 41 is inserted into insertion groove 43. Therefore, in the present embodiment, slide direction 45 of slide portion 41 is a direction along the radial direction of chuck main body 31. In the following description, a direction, which is parallel to upper surface 31A of chuck main body 31 (one example of the attachment surface of the present disclosure) and is orthogonal to slide direction 45 (radial direction), is referred to as width direction 46. Width direction 46 is, for example, a direction orthogonal to both slide direction 45 and the main spindle direction.

Slide portion 41 includes main body portion 41A and pair of flange portions 41B. A shape obtained by cutting main body portion 41A in a plane orthogonal to slide direction 45 has opening 41C on the side of upper surface 31A, and has a U-shape curved at substantially 90°. Main body portion 41A has edge portion 41D formed on a side opposite to opening 41C in the main spindle direction. Edge portion 41D is formed into a substantially straight line shape along width direction 46 when viewed from an outer side in slide direction 45. Each of pair of flange portions 41B is formed to protrude outward from both lower end portions of main body portion 41A in width direction 46 along edge portion 41D. Insertion groove 43 is formed by providing chuck main body 31 in a recessed manner to correspond to outer shapes of main body portion 41A and flange portion 41B.

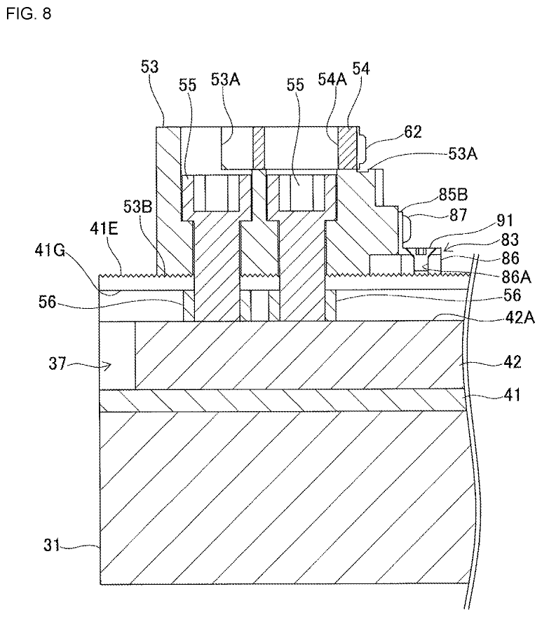

Serration portions 41E are formed, respectively, on upper surfaces of both ends of main body portion 41A forming a U-shape (surface on the side of upper surface 31A). Each of pair of serration portions 41E is subjected to serration machining to form multiple protrusions having a triangular shape along width direction 46, and the multiple protrusions are continuously formed at equal intervals in slide direction 45. Reception portion 42 has a rod shape which is long in slide direction 45 and of which a cross section cut in a plane perpendicular to slide direction 45 has a substantially semicircular shape. In main body portion 41A, insertion groove 41F provided in a recessed manner to correspond to an outer shape of reception portion 42 is formed in opening 41C. Reception portion 42 is inserted into insertion groove 41F and is held by slide portion 41. A plane parallel to upper surface 31A (parallel to slide direction 45 and width direction 46) is formed on upper surface 42A of reception portion 42. In insertion groove 41F, pair of nut grooves 41G provided in a recessed manner on both sides in width direction 46 are formed at positions above reception portion 42. Nuts 56 (see FIG. 8) described later are inserted into pair of nut grooves 41G.

As shown in FIG. 2, each of left side and right side main spindle devices 12L and 12R includes, for example, hydraulic cylinder 47 as a driving source for causing three attachment portions 37 of chuck main body 31 to move by sliding in slide direction 45. Three attachment portions 37 provided on one chuck main body 31 move by sliding in synchronization with slide direction 45, for example, in accordance with the driving of hydraulic cylinder 47. For example, control device 15 causes attachment portion 37 to move by sliding to an inner side in slide direction 45 (inner side in the radial direction) by pressurizing hydraulic cylinder 47, and causes attachment portion 37 to move by sliding to the outer side in slide direction 45 (outer side in the radial direction) by depressurizing hydraulic cylinder 47. As a result, control device 15 causes first and second chuck claws 32 to 34 attached to attachment portion 37 to move by sliding to execute the clamping or cancellation of the clamping of workpiece W.

As shown in FIG. 2, each of left side and right side main spindle devices 12L and 12R is provided with electromagnetic proportional depressurizing valve 49 for adjusting a hydraulic pressure of hydraulic cylinder 47. Control device 15 adjusts the hydraulic pressure of hydraulic cylinder 47 by controlling electromagnetic proportional depressurizing valve 49 of each of left side and right side main spindle devices 12L and 12R. As a result, control device 15 can change the force (clamping force) by which first and second chuck claws 32 to 34 attached to attachment portion 37 clamp workpiece W to correspond to the rigidity of workpiece W and the magnitude of the distortion that occurs. Hydraulic cylinder 47 is an example of a driving source of the present application. The driving source for moving first and second chuck claws 32 to 34 is not limited to the hydraulic cylinder, but may be another fluid pressure cylinder, such as an air cylinder. Alternatively, the driving source is not limited to the fluid pressure cylinder, but may be another driving source, such as a motor.

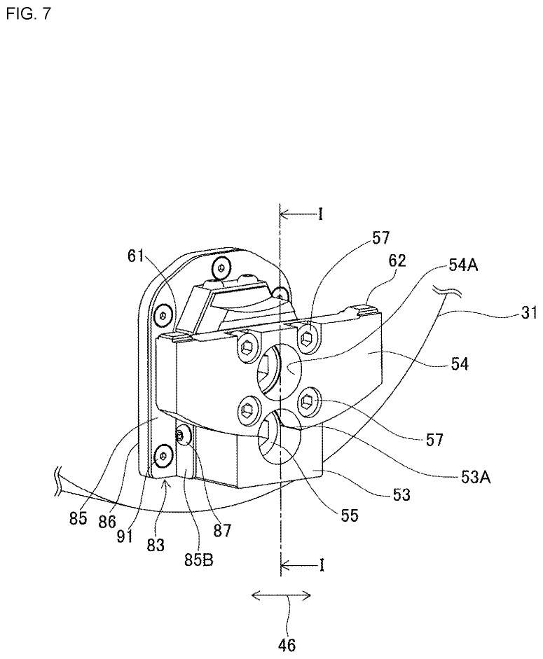

As shown in FIGS. 4 and 5, each of first chuck claws 32 and 33 includes main claw 51 and sub claw 52. Second chuck claw 34 includes main claw 53 and sub claw 54. First, second chuck claw 34 will be described. As shown in FIGS. 7 and 8, main claw 53 is a metallic member having a predetermined thickness in the main spindle direction. Notch portion 53A on which sub claw 54 can be placed is formed on an upper surface of main claw 53. Sub claw 54 is, for example, a plate member made of a metal long in width direction 46 and thin in the main spindle direction, and is formed into an arc shape in which three sides are formed into a straight line shape and the remaining one side is expanded to the outside. Notch portion 53A of main claw 53 is curved and notched to correspond to the arc shape of sub claw 54, and comes into contact with an arc-shaped part of sub claw 54 from the outer side in slide direction 45. As a result, when sub claw 54 clamps one side of workpiece W, the outward movement of sub claw 54 in slide direction 45 is regulated.

Serration portion 53B having the same shape as serration portion 41E of slide portion 41 is formed on a lower surface of main claw 53. For example, a user determines a position at which main claw 53 is attached to slide portion 41 in slide direction 45, that is, a position at which second chuck claw 34 is attached, with the number of peaks of serration portion 41E as a reference. The user disposes main claw 53 on slide portion 41 such that serration portions 41E and 53B are engaged with each other at predetermined peak positions. The predetermined peak position is a position to correspond to the size of workpiece W.

In addition, for example, two bolts 55 are inserted into main claw 53, and main claw 53 is attached to attachment portion 37. For example, bolt 55 is inserted into main claw 53 along the main spindle direction, and a distal end thereof is screwed into nut 56 inserted into nut groove 41G of slide portion 41. Bolt 55 is screwed, for example, to a position at which the distal end thereof comes into contact with upper surface 42A of reception portion 42, and the position in the main spindle direction is fixed. Main claw 53 is fixed to attachment portion 37 by meshing serration portions 41E and 53B and screwing two bolts 55 to nut 56. Through-hole 54A is formed in sub claw 54 to correspond to the position at which bolt 55 is inserted.

Sub claw 54 is fixed on main claw 53 by, for example, four bolts 57. The method of attaching main claw 53 to attachment portion 37 and the method of attaching sub claw 54 to main claw 53 are examples. For example, main claw 53 may be fixed to attachment portion 37 using a screw, a rivet, a clamp member, or the like. Similarly, sub claw 54 may be fixed to main claw 53 using a screw or the like. The same applies to a method of attaching main claw 51 and sub claw 52 of first chuck claws 32 and 33 described later.

An inner side edge portion of sub claw 54 in slide direction 45 is formed into a straight line shape along width direction 46, for example. Pair of second contact portions 61 and 62 are formed on the inner side edge portion. Second contact portions 61 and 62 are formed, for example, at both ends of sub claw 54 in width direction 46, respectively. Second contact portions 61 and 62 of the present embodiment are disposed at symmetrical positions with center 78 (see FIG. 4) of sub claw 54 in width direction 46 interposed therebetween. Each of second contact portions 61 and 62 is formed with a surface that comes into contact with workpiece W. In the following description, the surfaces of first contact portions 71 and 72 and second contact portions 61 and 62 coming into contact with workpiece W may be referred to as clamp surfaces.

FIG. 9 shows a state in which workpiece W is clamped by first and second chuck claws 32 to 34. FIG. 9 shows a state in which cover member 83 described later is detached. As shown in FIG. 9, machine tool 1 of the present embodiment executes, for example, machining on workpiece W having a substantially square outer shape as workpiece W. Workpiece W is formed with through-hole H which has a circular shape and passes through workpiece W in the thickness direction (main spindle direction). In the closed state, second chuck claw 34 holds (clamps) side 63 by bringing each of second contact portions 61 and 62 into contact with one side 63 of workpiece W at positions closer to both ends (corners). It is suitable that second chuck claw 34 brings the clamp surface of each of second contact portions 61 and 62 into surface contact with side 63 in a parallel state.

Next, first chuck claws 32 and 33 will be described. In the following description, descriptions of portions (for example, a mechanism of nut 56 fixed to attachment portion 37) having similar configurations to portions of second chuck claw 34 will be omitted as appropriate. Main claws 51 of first chuck claws 32 and 33 have a similar configuration. Sub claws 52 of first chuck claws 32 and 33 have an inverted shape in width direction 46. Therefore, in the following description, first chuck claw 32 will be mainly described, and the description of first chuck claw 33 will be omitted as appropriate. In addition, when main claw 51 and sub claw 52 of first chuck claw 32 are described in a distinguished manner from main claw 51 and sub claw 52 of first chuck claw 33, the description will be made by referring main claw 51 and sub claw 52 of first chuck claw 32 as main claw 51A and sub claw 52A (in a case of second chuck claw 34, main claw 51 and sub claw 52 are referred to as main claw 51B and sub claw 52B).

As shown in FIGS. 4, 5, and 10, main claw 51A is a metallic member having a predetermined thickness in the main spindle direction, and is attached to attachment portion 37 (see FIGS. 6 and 8) by multiple (for example, two) bolts 65. Although detailed descriptions are omitted, a serration portion is formed on a lower surface of main claw 51A in the same manner as main claw 53. Main claw 51A is attached to attachment portion 37 in a state in which the serration portion is meshed with serration portion 41E of attachment portion 37. In addition, bolt 65 is screwed into nut 56 (see FIG. 8) inserted into nut groove 41G of attachment portion 37, thereby fixing main claw 51A to attachment portion 37.

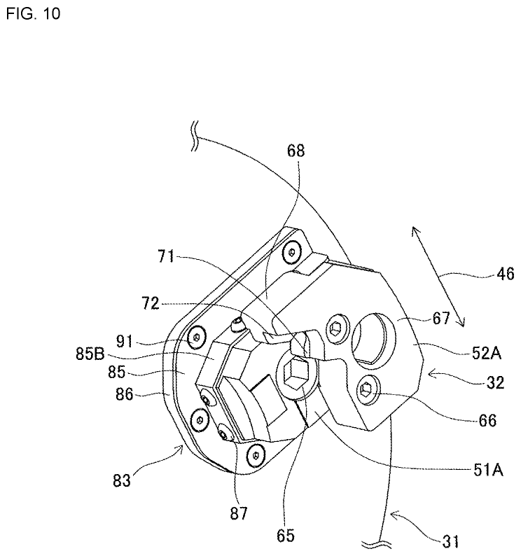

Sub claw 52A is placed on main claw 51A. Sub claw 52A is a metallic member having a plate shape and a predetermined thickness in the main spindle direction. Sub claw 52A includes main body portion 67 having a predetermined width in slide direction 45 and width direction 46. Main body portion 67 is fixed to an upper surface of main claw 51A by multiple (for example, two) bolts 66. In addition, protruding portion 68 is formed on sub claw 52A. Protruding portion 68 is formed once in width direction 46 of main body portion 67 (in a case of FIG. 10, an end portion on a left side in the circumferential direction or a counterclockwise side). Protruding portion 68 protrudes from an end portion of main body portion 67 toward the inner side in slide direction 45.

As described above, first and second chuck claws 32 to 34 are fixed to attachment portion 37. Therefore, control device 15 can integrally move first and second chuck claws 32 to 34 together with attachment portion 37 by driving hydraulic cylinder 47 and moving three attachment portions 37 in slide direction 45. As a result, control device 15 can open and close first and second chuck claws 32 to 34 to execute the chucking and cancellation the chucking of workpiece W.

Pair of first contact portions 71 and 72 are formed on sub claw 52A. First contact portion 71 is formed on an inner peripheral surface of main body portion 67 in slide direction 45 and at a position close to protruding portion 68 in width direction 46. First contact portion 72 is formed on an inner peripheral surface of protruding portion 68. As shown in FIG. 9, first contact portions 71 and 72 come into contact with each of two sides 63 forming the corner of workpiece W, thereby holding the corner of workpiece W. It is suitable that first chuck claws 32 and 33 bring the clamp surface of each of first contact portions 71 and 72 into surface contact with each side 63 in a parallel state.

As indicated by dashed lines in FIG. 4, in a case where workpiece W is clamped (in the clamped state), the total of six contact portions of pair of first contact portions 71 and 72 provided on each of two first chuck claws 32 and 33 and pair of second contact portions 61 and 62 provided on second chuck claw 34 are disposed at positions facing each other in a direction parallel to side 63 of workpiece W, respectively. Specifically, for example, first contact portion 71 of first chuck claw 32 is disposed at a position facing first contact portion 71 of first chuck claw 33 in the direction parallel to side 63. Here, side 63 is side 63 clamped between first contact portion 71 of first chuck claw 32 and first contact portion 71 of first chuck claw 33. For example, first contact portion 71 of first chuck claw 33 is disposed at a position separated from the clamp surface of first contact portion 71 of first chuck claw 32 by a length of side 63 along the direction perpendicular to the clamp surface.

Similarly, first contact portion 72 of first chuck claw 32 is disposed at a position facing second contact portion 62 of second chuck claw 34 in the direction parallel to side 63. In addition, first contact portion 72 of first chuck claw 33 is disposed at a position facing second contact portion 61 of second chuck claw 34 in the direction parallel to side 63.

Here, depending on the position at which the contact portion is contacted to clamp workpiece W, that is, the position at which the clamping force is applied to workpiece W, there is a concern that the distortion occurs in workpiece W. In particular, as shown in FIG. 9, in a case where workpiece W is viewed in plan view, for example, in workpiece W in which an area of through-hole H is about 50% or more of the entire area of workpiece W, the thickness around through-hole H is reduced. Workpiece W is formed with a thin part having a small thickness between through-hole H and side 63. In workpiece W having such a thin part, in a case where the clamping force is not applied in a well-balanced manner, the distortion of workpiece W occurs when the clamping force is applied or after the applied clamping force is released. For example, a shape of through-hole H is distorted from a desired shape (for example, a perfect circle). On the other hand, in chuck main body 31 of the present embodiment, in the clamped state of workpiece W, the contact portions are disposed at positions facing each other with workpiece W interposed therebetween. As a result, by applying the clamping force from both sides of workpiece W, it is possible to effectively suppress the distortion that occurs in workpiece W.

In addition, out of pair of first contact portions 71 and 72, the clamp surface of first contact portion 72 (first one of first contact portions 71 and 72) disposed at the position facing second contact portions 61 and 62 is larger than the clamp surface of first contact portion 71 (second one of first contact portions 71 and 72). As shown in an enlarged view of FIG. 4, a length of first contact portion 72 in the direction parallel to side 63 is longer than a length of first contact portion 71 in the direction parallel to side 63. In addition, the lengths of the clamp surfaces of first contact portions 71 and 72 in the main spindle direction are, for example, the same. With this configuration, by making the clamp surface of first contact portion 72 facing second chuck claw 34 holding one side 63 larger, it is possible to balance the clamping force of second contact portions 61 and 62, and suppress the distortion that occurs in workpiece W. The clamp surfaces of first contact portions 71 and 72 may have the same area. In addition, the clamp surface of first contact portion 72 may be smaller than the clamp surface of first contact portion 71.

Perpendicular lines of first contact portions 71 and 72 intersect with each other at the corner of workpiece W (part in which through-hole H is not formed). Specifically, in workpiece W, a region formed at the corner of workpiece W in the region in which through-hole H is not formed is defined as non-formation region 73 (see FIG. 9). In addition, as shown in an enlarged view of FIG. 4, a point at which straight line 74 perpendicular to the clamp surface of first contact portion 71 and straight line 75 perpendicular to the clamp surface of first contact portion 72 intersect with each other is defined as intersection point 76. In this case, as shown in FIG. 9, intersection point 76 is disposed in non-formation region 73 in the clamped state of workpiece W. In other words, pair of first contact portions 71 and 72 are disposed at positions closer to each other and at positions closer to the corner of workpiece W as intersection point 76 is disposed closer to non-formation region 73. As a result, both first contact portions 71 and 72 can be brought into contact with positions closer to the corner at which a distance between through-hole H and side 63 is long (thick part) instead of the thin part, and the distortion that occurs in workpiece W can be suppressed.

Further, in the present embodiment, since each of second contact portions 61 and 62 is disposed at a position facing first contact portion 72, each of second contact portions 61 and 62 is disposed at a position close to the corner of workpiece W. As a result, it is possible to suppress the distortion that occurs in workpiece W by the clamping force applied from second contact portions 61 and 62.

As shown in FIG. 4, second contact portions 61 and 62 are disposed at symmetrical positions with center 78 of the second chuck claw in width direction 46 interposed therebetween. For example, main claw 53 and sub claw 54 have a configuration symmetrical with respect to a straight line which passes through center 78 and is parallel to slide direction 45. Therefore, center 78 is a midpoint of main claw 53 or sub claw 54 in width direction 46. For example, a distance between center 78 and second contact portion 61 in width direction 46 is the same as a distance between center 78 and second contact portion 62 in width direction 46. With this configuration, the clamping force can be more uniformly applied to workpiece W from second contact portions 61 and 62 of second chuck claw 34 that moves by sliding. The disposition or the number of second contact portions 61 and 62 shown in FIG. 4 are examples. For example, second contact portions 61 and 62 may be disposed on one side of center 78 in width direction 46. Alternatively, a configuration may be adopted in which sub claw 54 includes one second contact portion or includes three or more second contact portions. In addition, an edge portion of sub claw 54 on the side of workpiece W may be configured as one second contact portion along side 63.

In a case where a straight line, which passes through center 79 of first chuck claw 32 in width direction 46 and is parallel to slide direction 45, is defined as straight line 81, pair of first contact portions 71 and 72 are disposed on one side of straight line 81 in width direction 46. Both first contact portions 71 and 72 are disposed on sides opposite to second chuck claw 34 (second contact portions 61 and 62) with straight line 81 in width direction 46 interposed therebetween. With this configuration, center 79 of first chuck claws 32 and 33 in width direction 46 can be made close to second chuck claw 34 while first chuck claws 32 and 33 are disposed at positions close to the corner. As a result, a distance between first and second chuck claws 32 to 34 can be shortened, and chuck main body 31 can be downsized. The disposition or the number of first contact portions 71 and 72 shown in FIG. 4 are examples. For example, first contact portions 71 and 72 may be disposed on both sides with center 79 in width direction 46 interposed therebetween. Alternatively, a configuration may be adopted in which sub claw 52A includes three or more first contact portions.

### Cover Member 83

Next, cover member 83 will be described. As shown in FIGS. 4 and 5, cover member 83 is attached to main claws 51 and 53 of first and second chuck claws 32 to 34, respectively. Three cover members 83 have substantially the same structure. Therefore, in the following description, cover member 83 attached to main claw 53 of second chuck claw 34 will be described.

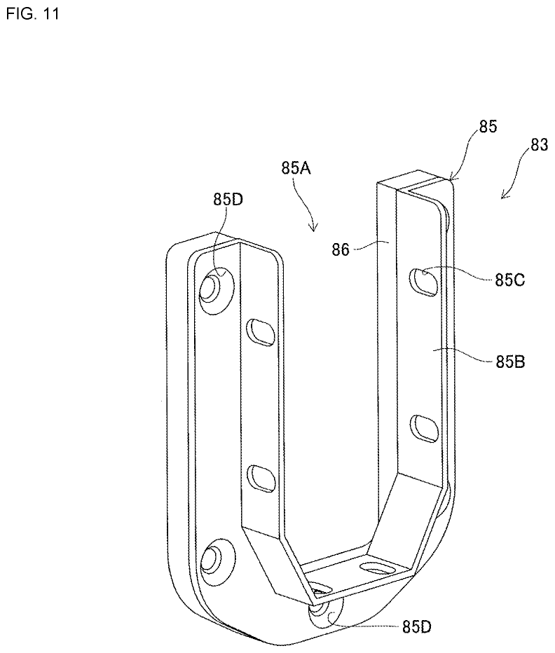

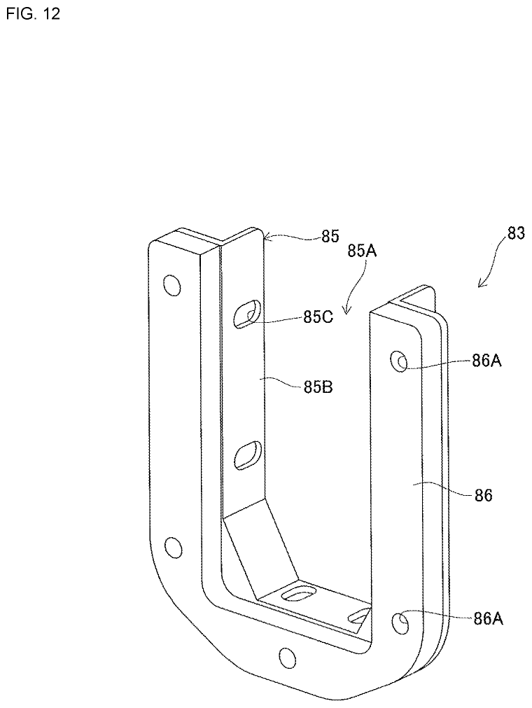

FIGS. 11 and 12 show perspective views of cover member 83. As shown in FIGS. 7, 8, 11, and 12, cover member 83 has bracket 85 and blocking member 86. Bracket 85 is, for example, steel plate hot commercial (SPHC) and is formed into a substantially U-shape. Bracket 85 is not limited to SPHC, but may be a metal plate machined by another machining method, such as steel plate cold commercial (SPCC).

Bracket 85 is formed with insertion portion 85A which is bent to correspond to an outer shape of main claw 53 and into which main claw 53 is inserted. Insertion portion 85A is a groove long in slide direction 45, and is formed to correspond to the shape of main claw 53 to extend along an outer periphery of main claw 53. Therefore, by attaching bracket 85 to main claw 53, an inner peripheral surface of insertion portion 85A can be attached by being brought into close contact with a base portion of main claw 53 (end portion part on the side of chuck main body 31).

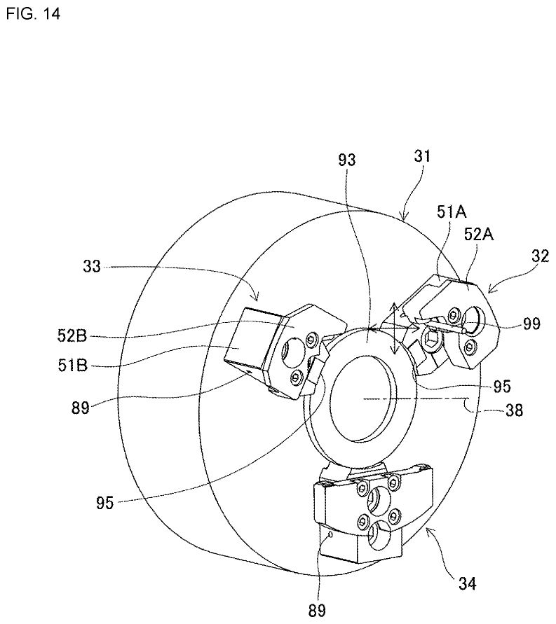

Bracket 85 is provided with attachment portion 85B extending in the main spindle direction. Attachment portion 85B is formed along insertion portion 85A (outer peripheral surface of main claw 53) to have a fixed width in the main spindle direction and to surround the base portion of main claw 53. Multiple bolt holes 85C are formed in attachment portion 85B. Bracket 85 is fixed to main claw 53 by screwing bolts 87 (see FIG. 7) inserted into multiple bolt holes 85C to bolt holes 89 (see FIG. 14) formed in main claw 53. Therefore, each of three cover members 83 is attached to the base portion of each of main claws 51 and 53 in a state in which main claws 51 and 53 of first and second chuck claws 32 to 34 are inserted into insertion portion 85A, respectively.

Here, in the configuration in which first and second chuck claws 32 to 34 are attached to chuck main body 31 in an exchangeable manner as in chuck main body 31 of the present embodiment, there is a concern that a scrap enters a gap between first and second chuck claws 32 to 34 and chuck main body 31 or attachment portion 37. When the scrap is interposed in the gap, there is a concern that a failure occurs in opening and closing operations of first and second chuck claws 32 to 34, or a failure occurs in a chuck operation due to the scrap clamped between first and second chuck claws 32 to 34 and workpiece W. Therefore, cover member 83 can be attached to first and second chuck claws 32 to 34 of the present embodiment in order to prevent the scrap from entering the gap. As a result, it is possible to suppress the entering of the scrap and suppress the occurrence of the above-described failure.

Further, blocking member 86 is provided on cover member 83. As the material of blocking member 86, for example, MC Nylon (registered trademark) can be used. The material of blocking member 86 is not limited to MC nylon (registered trademark), and may be urethane, rubber, or the like. Blocking member 86 is formed into a substantially U-shape to correspond to the shape of bracket 85, that is, to correspond to the shape of main claw 53.

As shown in FIGS. 4 and 5, each of three cover members 83 is attached to each of first and second chuck claws 32 to 34 on the inner side (inner side in the radial direction) as the side of workpiece W in slide direction 45. In addition, cover member 83 is formed into a shape in which bracket 85 or blocking member 86 is curved along the outer peripheral surface of each of first and second chuck claws 32 to 34. As a result, by disposing cover member 83 on the gap at a position on the side of workpiece W, it is possible to more reliably prevent the scrap generated from workpiece W from entering the gap.

In addition, multiple through-holes 85D are formed in bracket 85 on a surface to which blocking member 86 is attached (see FIG. 11). In addition, a screw hole 86A is formed in blocking member 86 to correspond to the position of each of multiple through-holes 85D (see FIG. 12). Blocking member 86 is fixed to bracket 85 by screwing screw 91 inserted into each of multiple through-holes 85D into screw hole 86A. Blocking member 86 is disposed at a position interposed between chuck main body 31 and bracket 85. The method of attaching blocking member 86 to bracket 85 is not limited to the method using screw 91, but a method using a bolt may be adopted. Alternatively, bracket 85 and blocking member 86 may be integrally formed by insert molding.

Cover member 83 is attached to main claws 51 and 53 in a state in which blocking member 86 comes into contact with upper surface 31A of chuck main body 31. Blocking member 86 of each cover member 83 is provided at a position at which a lower surface thereof is brought into contact with chuck main body 31 to block the gap between each of first and second chuck claws 32 to 34 and chuck main body 31 from the outside. As a result, it is possible to block the gap from the outside to prevent the scrap from entering the gap.

Here, as described above, since blocking member 86 is provided at a position coming into contact with chuck main body 31, there is a concern that blocking member 86 is worn as first and second chuck claws 32 to 34 move by sliding. Blocking member 86 has a predetermined thickness (for example, a thickness of a few millimeters) in the main spindle direction. As shown in FIG. 8, the thickness is a length obtained by adding a predetermined excess to a length of a part of screw 91 that is screwed (inserted) to screw hole 86A. The excess length is a length that is allowable as a length (thickness) that will be worn away. In addition, as shown in FIG. 11, bolt hole 85C of bracket 85 is formed as a long hole which is long in the main spindle direction. As a result, when blocking member 86 is worn and thinned, the user can adjust the insertion position of bolt 87 in bolt hole 85C of the long hole, and move the attachment position of cover member 83 in the main spindle direction toward the side of chuck main body 31 to bring blocking member 86 into contact with chuck main body 31. Therefore, the position of blocking member 86 can be adjusted to continuously prevent the scrap from entering.

The configuration of cover member 83 described above is an example. For example, cover member 83 need not include blocking member 86. In this case, the entering of the scrap into the gap may be suppressed only by bracket 85. In addition, bracket 85 or blocking member 86 need not have a shape along the outer shape of main claw 53. For example, there may be a gap between the outer peripheral surface of main claw 53 and an inner peripheral surface of bracket 85 or blocking member 86.

### Adjustment of First and Second Contact Portions 71, 72, 61, and 62

Next, the work of machining and adjusting first and second contact portions 71, 72, 61, and 62 (hereinafter, may be referred to as first contact portion 71 or the like) will be described. FIG. 13 is a plan view of chuck main body 31 to which first and second chuck claws 32 to 34 are attached, and shows a state in which cover member 83 is detached. FIG. 14 shows a state in which adjustment ring 93 is clamped by first and second chuck claws 32 to 34.

In machine tool 1 of the present embodiment, a predetermined amount of clearances 97 can be provided in advance in first contact portion 71 or the like, and unnecessary parts can be removed from clearance 97 in a state in which adjustment ring 93 is clamped. Specifically, as shown in FIG. 13, adjustment recessed portion 95 is formed on the surfaces on the inner peripheral side of main claws 51 and 53 in slide direction 45 (inner side part facing another main claw). As shown in FIG. 14, adjustment ring 93 is, for example, a metal member having an annular shape. Each adjustment recessed portion 95 is notched in an arc shape to correspond to the outer shape of adjustment ring 93.

Three main claws 51 and 53 move by sliding in synchronization with slide direction 45 in accordance with the driving of hydraulic cylinder 47. As shown in FIG. 14, the center of adjustment ring 93 clamped by three adjustment recessed portions 95 matches, for example, the position of main spindle 38. The radius of adjustment ring 93 is set to a length to correspond to the size of workpiece W which is a machining target. Therefore, in a state in which adjustment ring 93 is clamped between main claws 51 and 53, first and second chuck claws 32 to 34 dispose first contact portion 71 or the like at a position at which workpiece W is clamped.

There is a concern that the position of first contact portions 71 or the like deviates due to an attachment error or the like of the work for attaching first and second chuck claws 32 to 34 to main claws 51 and 53. Therefore, machine tool 1 machines clearance 97 provided on first contact portion 71 or the like to correspond to the position at which machine tool 1 comes into contact with the clamp surface of workpiece W. As a result, the clamp surface of first contact portion 71 or the like can be accurately brought into contact with workpiece W. A thickness of clearance 97 is, for example, a few millimeters to a few tenths of a millimeter. In order to facilitate understanding of the position of clearance 97, FIG. 14 shows clearance 97 larger than the actual size.

Control device 15 controls left side main spindle device 12L, for example, based on an operation input to touch panel 3A, and clamps adjustment ring 93 by main claws 51 and 53. In a state in which adjustment ring 93 is clamped, control device 15 cuts clearances 97 of first and second contact portions 71, 72, 61, and 62 by left side turret 13L or tool main spindle device 21. That is, the position or the shape of the clamp surface of first contact portion 71 or the like is adjusted to correspond to a quadrangular shape of workpiece W. The user inputs, for example, the coordinates of the position of side 63 or the position at which workpiece W is clamped, with the position of main spindle 38 on touch panel 3A as a reference. As indicated by arrows in FIG. 14, control device 15 brings end mill 99 of tool main spindle device 21 into contact with clearance 97, for example, based on the input coordinates, moves end mill 99 in a direction along side 63 of workpiece W, and cuts clearance 97. As a result, even in a case where the attachment error of first and second chuck claws 32 to 34 or a machining error of workpiece W in the preceding process occurs, the shape or the position of the clamp surface of first contact portion 71 or the like can be adjusted at the manufacturing site, and first contact portion 71 or the like can be brought into close contact with workpiece W accurately.

Incidentally, left side main spindle device 12L and right side main spindle device 12R are examples of a workpiece clamping device and a main spindle device. Hydraulic cylinder 47 is an example of a driving source. A direction parallel to main spindle 38 is an example of a thickness direction. Upper surface 31A is an example of an attachment surface. Bolt 87 is an example of a screw member. Bolt hole 85C is an example of an insertion hole. Left side and right side turrets 13L and 13R are examples of a machining device. Tool main spindle device 21 is an example of a machining device. Adjustment ring 93 is an example of an adjustment member.

As described above, according to the present embodiment described above, the following advantageous effects can be achieved.

In one aspect of the present embodiment, first chuck claws 32 and 33 are disposed at positions of different corner, respectively, on workpiece W having the rectangular shape, and each of pair of first contact portions 71 and 72 is brought into contact with two sides forming the corner to hold the corner. In addition, second chuck claw 34 holds one side of workpiece W by bringing second contact portions 61 and 62 into contact with side 63 of workpiece W. With this configuration, two corners of workpiece W having the rectangular shape are held by two first chuck claws 32 and 33, respectively, while one side is held by second chuck claw 34. It is possible to suppress a positional deviation that occurs when workpiece W having the rectangular shape is clamped, and it is possible to clamp workpiece W having the rectangular shape accurately. In addition, chuck main body 31 described above can be used as a general three-way claw chuck by changing the types of first and second chuck claws 32 to 34. Therefore, it is unnecessary to detach and exchange chuck main body 31 from left side and right side main spindle devices 12L and 12R in changeover of workpiece W, and it is possible to clamp workpiece W having the rectangular shape as well as the workpiece W having the circular shape by using the same chuck main body 31.

In a case where workpieces W having various shapes are clamped in this manner, control device 15 needs to adjust the clamping force to correspond to workpiece W. Each of left side and right side main spindle devices 12L and 12R of the present embodiment includes electromagnetic proportional depressurizing valve 49. For example, identification information (workpiece NO) of workpiece W which is the machining target and the data associating the NC program used to machine workpiece W are stored in storage device 15B. In the NC program, a current value of electromagnetic proportional depressurizing valve 49 to correspond to the clamping force suitable for workpiece W is set. The clamping force suitable for workpiece W as used herein is the clamping force to correspond to the shape or the rigidity of workpiece W. Control device 15 can adjust the hydraulic pressure of hydraulic cylinder 47 to obtain the clamping force suitable for workpiece W by reading out the NC program to correspond to the identification information from storage device 15B and executing the NC program. As a result, it is possible to suppress the distortion that occurs in workpiece W during the chucking. Control device 15 may determine the optimal clamping force by analyzing, for example, the shape, the machining content, the rigidity, and the like of workpiece W which is the machining target, and adjust the clamping force by controlling the current value of electromagnetic proportional depressurizing valve 49. In addition, a configuration may be adopted in which left side and right side main spindle devices 12L and 12R do not include electromagnetic proportional depressurizing valve 49.

In addition, machine tool 1 of the present embodiment is the multifunctional machining machine including left side and right side turrets 13L and 13R, and tool main spindle device 21. With this configuration, it is possible to execute various types of machining using the lathe, the rotating tool, or the like in a state where workpiece W having the rectangular shape is clamped by left side main spindle device 12L or right side main spindle device 12R, that is, in the clamped state of one workpiece. Therefore, in a case where various types of machining are executed on workpiece W having the rectangular shape, it is possible to suppress the occurrence of the positional deviation between the respective types of machining.

Left side and right side main spindle devices 12L and 12R are so-called facing biaxial-type main spindle devices. Tool main spindle device 21 is disposed between left side and right side main spindle devices 12L and 12R in the direction parallel to main spindle 38. Control device 15 of the present embodiment can execute machining using adjustment ring 93 on sub claws 52 and 54 of each of left side and right side main spindle devices 12L and 12R. With this configuration, by providing the rotating tool, such as end mill 99, in tool main spindle device 21, it is possible to execute the cutting on clearance 97 of both left side and right side main spindle devices 12L and 12R by one tool main spindle device 21.

The present disclosure is not limited to the above-described embodiment, and it is needless to say that various improvements and changes can be made without departing from the gist of the present disclosure.

For example, the configurations of chuck main body 31, first and second chuck claws 32 to 34 shown in FIGS. 4 to 6 in the above-described embodiment are examples. For example, the positions at which first and second chuck claws 32 to 34 are disposed need not have intervals of 120 degrees in the circumferential direction of chuck main body 31. The number of chuck claws attachable to chuck main body 31 is not limited to three, but may be four or more. Therefore, the number of first chuck claws 32 and 33 may be three or more, and the number of second chuck claws 34 may be two or more.

The shape of workpiece W in the above-described embodiment is an example. Workpiece W may have a polygonal shape having a pentagonal or more shape. In addition, workpiece W need not be formed with through-hole H.

In the above-described embodiment, all the contact portions are provided at positions facing other contact portions in the direction parallel to side 63 of workpiece W in the clamped state of workpiece W, but the present disclosure is not limited to this. For example, first contact portion 72 may be disposed at a position deviated from the position facing second contact portions 61 and 62. In addition, with respect to respective first contact portions 71 of first chuck claws 32 and 33, a first one of first contact portions 71 may be disposed at a position deviated from a position facing a second one of first contact portions 71.

In addition, the workpiece clamping device of the present disclosure is not limited to a device that rotates workpiece W, such as left side main spindle device 12L. For example, the workpiece clamping device may be a workpiece clamping device used in a device that does not rotate the workpiece, such as a machining center or a milling machine.

The positions of first contact portions 71 and 72 may be adjusted such that intersection point 76 of the clamp surfaces is disposed outside non-formation region 73.

Left side and right side main spindle devices 12L and 12R may have a configuration in which cover member 83 is not attachable. That is, machine tool 1 need not include cover member 83.

The screw member of the present disclosure is not limited to bolt 87, but may be another member to be screwed, such as a screw.

Bolt hole 85C is not limited to a long hole, but may be a circular hole.

The adjustment member of the present disclosure is not limited to an annular member, such as adjustment ring 93, but may be a member having a polygonal shape, such as a quadrangular shape. In this case, the shape of adjustment recessed portion 95 may be appropriately changed to a rectangular shape or the like.

Cover member 83 may have an annular shape that covers the entire circumference of main claws 51 and 53. Alternatively, cover member 83 may have a U-shape fitted from the outside of first and second chuck claws 32 to 34 in slide direction

A configuration may be adopted in which cover member 83 is attached to sub claws 52 and 54.

Left side and right side machining devices 11L and 11R are not limited to the facing biaxial-type lathes, but may be parallel biaxial-type lathes.

The machine tool of the present disclosure is not limited to the multifunctional machining machine, and various machine tools, such as a horizontal-type lathe, a front-type lathe, a vertical-type lathe, a machining center, a milling machine, and a drilling machine, can be adopted.

In addition, the present description also discloses a technical idea in which, in Claim 4, [the workpiece clamping device according to Claim 1 or 2] is changed to [the workpiece clamping device according to any one of Claims 1 to 3]. In addition, the technical idea in which, in Claim 5, [the workpiece clamping device according to Claim 1 or 2] is changed to [the workpiece clamping device according to any one of Claims 1 to 4] is also disclosed. In addition, the technical idea in which, in Claim 6, [the workpiece clamping device according to Claim 1 or 2] is changed to [the workpiece clamping device according to any one of Claims 1 to 5] is also disclosed. In addition, the technical idea in which, in Claim 8, [the workpiece clamping device according to Claim 6] is changed to [the workpiece clamping device according to Claim 6 or 7] is also disclosed. In addition, the technical idea in which, in Claim 10, [the workpiece clamping device according to Claim 1 or 2] is changed to [the workpiece clamping device according to any one of Claims 1 to 9] is also disclosed.

### REFERENCE SIGNS LIST

1: machine tool, 12L: left side main spindle device (workpiece clamping device, main spindle device), 12R: right side main spindle device (workpiece clamping device, main spindle device), 13L, 13R: left side and right side turrets (machining device), 15: control device, 21: tool main spindle device (machining device), 31: chuck main body, 31A: upper surface (attachment surface), 32, 33: first chuck claw, 34: second chuck claw, 38: main spindle, 45: slide direction, 46: width direction, 47: hydraulic cylinder (driving source), 51, 51A, 51B, 53: main claw, 52, 52A, 52B, 54: sub claw, 61, 62: second contact portion, 63: side, 71, 72: first contact portion, 73: non-formation region, 78, 79: center, 81: straight line, 83: cover member, 85: bracket, 85C: bolt hole (insertion hole), 86: blocking member, 87: bolt (screw member), 93: adjustment ring (adjustment member), 95: adjustment recessed portion, W: workpiece

1. A workpiece clamping device comprising:
a chuck main body;
multiple first chuck claws attached to the chuck main body;
a second chuck claw attached to the chuck main body; and
a driving source configured to move the first chuck claws and the second chuck claw to clamp a workpiece having a rectangular shape,
wherein the multiple first chuck claws each have a pair of first contact portions, are disposed at positions of different corners, respectively, on the workpiece having the rectangular shape, and are each configured to bring each of the pair of first contact portions into contact with two sides forming the corner to hold the corner, and
the second chuck claw has a second contact portion, and is configured to bring the second contact portion into contact with one side of the workpiece having the rectangular shape to hold the one side of the workpiece.

2. The workpiece clamping device according to claim 1,
wherein two first chuck claws are provided as the multiple first chuck claws,
the second chuck claw has a pair of the second contact portions coming into contact with the one side of the workpiece at different positions, respectively,
the workpiece has a quadrangular shape, and
in a case where the workpiece is clamped, in a direction parallel to a side of the workpiece, any contact portion out of the pair of first contact portions provided on each of the two first chuck claws and the pair of second contact portions provided on the second chuck claw is disposed at a position facing another contact portion, and all the contact portions are disposed at positions facing other contact portions, respectively.

3. The workpiece clamping device according to claim 2,
wherein each of the pair of first contact portions has a clamp surface coming into contact with the workpiece, and
the clamp surface of a first one of the first contact portions, disposed at a position facing the second contact portion in the direction parallel to the side of the workpiece is larger than the clamp surface of a second one of the first contact portions.

4. The workpiece clamping device according to claim 1,
wherein the workpiece is formed with a through-hole passing through the workpiece in a thickness direction, and has a non-formation region that is a region in which the through-hole is not formed, at the corner,
each of the pair of first contact portions has a clamp surface coming into contact with the workpiece, and
in the first chuck claw, in a case where the workpiece is clamped, a straight line perpendicular to the clamp surface of a first one of the first contact portions and a straight line perpendicular to the clamp surface of a second one of the first contact portions intersect with each other in the non-formation region.

5. The workpiece clamping device according to claim 1
wherein the second chuck claw has a pair of the second contact portions coming into contact with the one side of the workpiece at different positions, respectively,
each of the first chuck claw and the second chuck claw is attached to the chuck main body to be movable by sliding in a slide direction, and
in a case where a direction, which is parallel to an attachment surface of the chuck main body to which each of the first chuck claw and the second chuck claw is attached and is orthogonal to the slide direction, is defined as a width direction,
the pair of second contact portions are disposed at symmetrical positions with a center of the second chuck claw in the width direction interposed therebetween, and
both the pair of first contact portions are disposed on sides opposite to the second contact portion with a straight line, which passes through a center of the first chuck claw in the width direction and is parallel to the slide direction, interposed therebetween.

6. The workpiece clamping device according to claim 1
wherein a cover member is attachable to each of the first chuck claw and the second chuck claw, and
the cover member is provided with an insertion portion into which each of the first chuck claw and the second chuck claw is inserted, and is attached to a base portion of each of the first chuck claw and the second chuck claw in a state in which each of the first chuck claw and the second chuck claw is inserted into the insertion portion.

7. The workpiece clamping device according to claim 6,
wherein each of the first chuck claw and the second chuck claw is attached to the chuck main body to be movable by sliding in a slide direction, and
the cover member is attached to each of the first chuck claw and the second chuck claw on an inner side as a workpiece side in the slide direction, and is formed into a shape curved along an outer peripheral surface of each of the first chuck claw and the second chuck claw.

8. The workpiece clamping device according to claim 6,
wherein the cover member includes
a bracket attached to the base portion of each of the first chuck claw and the second chuck claw, and
a blocking member attached to the bracket, and provided at a position coming into contact with the chuck main body to block a gap between each of the first chuck claw and the second chuck claw, and the chuck main body from an outside.

9. The workpiece clamping device according to claim 8,
wherein the bracket is formed with an insertion hole into which a screw member is inserted, and is attached to each of the first chuck claw and the second chuck claw by screwing the screw member inserted into the insertion hole to the base portion of each of the first chuck claw and the second chuck claw, and
the insertion hole is a long hole that is long in a direction perpendicular to an attachment surface of the chuck main body to which each of the first chuck claw and the second chuck claw is attached.

10. A machine tool comprising:
the workpiece clamping device according to claim 1;
a machining device configured to execute machining on the workpiece; and
a control device,
wherein each of the first chuck claw and the second chuck claw includes
a main claw attached to the chuck main body, and
a sub claw attached to the main claw and configured to clamp the workpiece,
the main claw has an adjustment recessed portion configured to clamp an adjustment member in an inner side part facing the main claw of another chuck claw, and
the control device is configured to control the workpiece clamping device so that the adjustment member is clamped in the adjustment recessed portion of the main claw provided on each of the first chuck claw and the second chuck claw, and to machine the sub claw to correspond to an outer shape of the workpiece having a rectangular shape by using the machining device in a state in which the adjustment member is clamped with multiple main claws.

11. The machine tool according to claim 10,
wherein the machining device includes a tool main spindle device,
the workpiece clamping device is a main spindle device provided in pairs and configured to rotate the workpiece about a main spindle,
a pair of the workpiece clamping devices are disposed at positions facing each other in a direction parallel to the main spindle, and
the tool main spindle device is disposed between the pair of workpiece clamping devices in the direction parallel to the main spindle, and is configured to execute machining of the sub claw to correspond to the outer shape of the workpiece having the rectangular shape on the sub claw of each of the pair of workpiece clamping devices.
